(19) United States
(12) Patent Application Publication
(10) Pub. No.: US 2005/0280951 A1
(43) Pub. Date: Dec. 22, 2005

(54) Magnetic recording/reading apparatus

(75) Inventors: Myoung-Joon Kim, Suwon-si (KR); Bong-Joo Kim, Suwon-si (KR); Jun-Young Kim, Suwon-si (KR); Chung-Hum Baik, Suwon-si (KR); Young-Ho Cho, Suwon-si (KR); Jae-Kab Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/114,034

(22) Filed: Apr. 26, 2005

(30) Foreign Application Priority Data
Jun. 17, 2004 (KR) 2004-44879

(51) Int. Cl. G11B 5/52

(52) U.S. Cl. 360/271.9

(57) ABSTRACT

A magnetic recording/reading apparatus comprises a head drum disposed on a deck to record or read information on/from a magnetic tape. An FPC fixing member is disposed on the deck to fix an FPC having a signal line to transmit a signal. The apparatus is configured to prevent noise generated between the head drum and the magnetic tape from transmitting to the outside and to a microphone. Thus, quality of recorded sound is improved.

### CROSS-REFERENCE TO RELATED APPLICATIONS

This application claims the benefit under 35 U.S.C. § 119 (a) of Korean Patent Application No. 2004-44879, filed on Jun. 17, 2004, the entire disclosure of which is hereby incorporated by reference.

### BACKGROUND OF THE INVENTION

1. Field of the Invention

The present invention relates to a magnetic recording/reading apparatus. More particularly, the present invention relates to a magnetic recording/reading apparatus with an improved structure to prevent noise from being transmitted to the outside of the apparatus.

2. Description of the Related Art

Generally, a magnetic recording/reading apparatus is provided with a head drum on which a head chip is mounted. The head chip mounted on the head drum contacts with a magnetic tape to record or read information.

FIG. 1 is a schematic perspective view of a conventional magnetic recording/reading apparatus. Referring to FIG. 1, the magnetic recording/reading apparatus comprises a deck 30 on which various components are mounted so as to record/read information on/from a magnetic tape. A head drum 10 is disposed on the deck 30 to rotatably contact with the magnetic tape and record/read information. A guide pole 20 is disposed on the deck 30 to guide the magnetic tape to contact the head drum 10. A holder 40 is movably disposed on the deck 30 so that a user may insert or withdraw the magnetic tape into/from the deck 30. Additionally, a flexible printed circuit (FPC) fixing member 50 is disposed on the deck 30 to fix an FPC 54 having a signal line 56 for transmitting various signals. The FPC fixing member 50 fixes the FPC 54 and protects the head drum 10 from impact when adjusting the guide pole 20 from the outside.

If the user inserts the magnetic tape into the holder 40, and then pushes down holder cover 44 disposed on the upper portion of the holder 40, the holder 40 is locked on the deck 30. Thus, the magnetic tape is safely settled on the deck 30. Then, the magnetic tape is withdrawn from a cartridge and guided by the guide pole 20. Accordingly, the magnetic tape contacts the head chip 14 disposed on the head drum 10. The head chip 14 reads or records the information. At this time, the magnetic tape is in contact with the rotating head chip 14, thereby generating noise. The noise is transmitted to the outside of the magnetic recording/reading apparatus. This noise is a nuisance and may often annoy a user. Furthermore, when recording the information on the magnetic tape, this noise also transmits to the microphone. Therefore, the noise is included with the information recorded on the magnetic tape, thereby deteriorating the quality of the recorded sound. Consequently, noise reduction studies are being performed; however, due to the size of the structure, it is relatively difficult to provide both a separate noise preventing structure and a magnetic recording/reading apparatus.

Accordingly, there is a need for a minimized magnetic recording/reading apparatus with an improved structure that prevents noise generated from the head drum from being transmitted to the outside of the apparatus.

### SUMMARY OF THE INVENTION

An aspect of the present invention is to solve at least the above problems and/or disadvantages and to provide at least the advantages described below. Accordingly, an aspect of the present invention is to provide a magnetic recording/reading apparatus with an improved structure of preventing noise generated from a head drum.

To achieve the above-described object, there is provided a magnetic recording/reading apparatus comprising a deck on which a magnetic tape is arranged. A head drum is disposed on the deck to record or read information on/from the magnetic tape. An FPC fixing member is disposed on the deck to fix an FPC having a signal line to transmit a signal. The FPC fixing member extends to an upper side of the head drum.

Preferably, the FPC fixing member is configured to cover only a contacting portion of head drum of which the magnetic tape contacts.

Preferably, the FPC fixing member further comprises a blocking shield disposed between a microphone and the head drum so as to exclude noise transmitted to the microphone.

Preferably, the magnetic recording/reading apparatus further comprises an acoustic absorption member attached to at least one surface of the FPC fixing member.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, and features, and advantages of certain embodiments of the present invention will be more apparent from the following description taken in conjunction with the accompanying drawings, in which:

FIG. 1 is a schematic perspective view of a conventional magnetic recording/reading apparatus;

FIG. 2 is a schematic perspective view of a magnetic recording/reading apparatus in accordance with a first embodiment of the present invention;

FIG. 3 is a schematic perspective view of the magnetic recording/reading apparatus in accordance with a second embodiment of the present invention;

FIG. 4 is a schematic perspective view of the magnetic recording/reading apparatus in accordance with a third embodiment of the present invention; and

FIG. 5 is a cross-sectional view of the FPC fixing member show in FIG. 4 taken along line V-V.

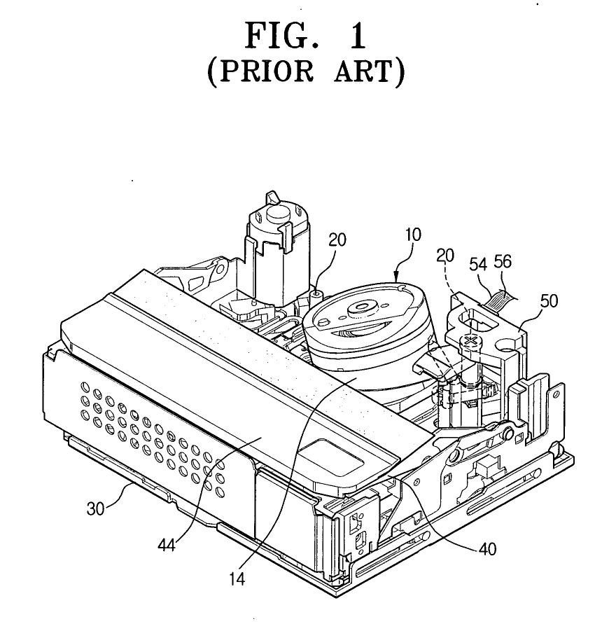

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for conciseness.

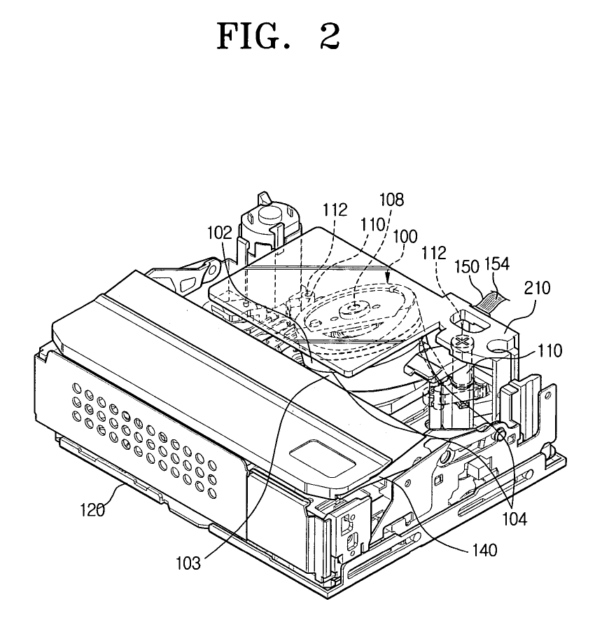

Referring to FIG. 2, a magnetic recording/reading apparatus according to a first embodiment of the present invention comprises a deck 120 in which various components are mounted to record/read information on/from a magnetic tape. A head drum 100 is disposed on the deck 120 to record/read the information on/from the magnetic tape. A guide pole 110 is also disposed on the deck 120 to guide the magnetic tape to the head drum 100. Next, a holder 140 is disposed on the deck 120 for vertical movement and to safely settle the magnetic tape in the deck 120. Lastly, a FPC fixing member 210 is disposed on the deck 120 to fix an FPC 150. The FPC 150 has a signal line 154 for transmitting various signals formed therein, and extends to an upper side of the head drum 100 to prevent noise generated at the head drum 100 from being transmitted to the outside.

In the deck 120, various components are disposed to drive the magnetic recording/reading apparatus. The magnetic tape is arranged therein and the information is recorded or read on or from the magnetic tape.

The head drum 100 is fixed on the deck 120 and is preferably inclined at a desired angle by a suitable fastener such as a bolt. The head drum 100 comprises a rotational drum 102 which rotates on a rotational shaft 108. The head drum 100 also includes a fixed drum 103 fixed to the rotational shaft 108 and the deck 120. A head chip 104 is disposed on the rotational drum 102 and protrudes from an outer surface of the rotational drum 102 to contact with the magnetic tape. The rotational drum 102 rotates by a desired amount due to a signal generated from a control portion (not shown). Due to the rotation of the rotational drum 102, the head chip 104 fixed to the rotational drum 102 protrudes from the outer surface thereof and contacts with the magnetic tape while being rotated. Due to the contact between the magnetic tape and the head chip 104, information may be recorded on the magnetic tape or the information recorded on the magnetic tape may be read.

The guide pole 110 guides the magnetic tape to stably contact the head drum 100. The guide pole 110 is formed with a groove 112 on a top portion thereof so that a height of the guide pole 110 may be adjusted from the outside by a tool such as a screwdriver.

The holder 140 is disposed on the deck 120 for vertical movement. When a user withdraws or inserts the magnetic tape, the holder 140 locks with the deck 120, and is released by a signal of the control portion. The holder then moves to an upper side of the deck 120 by a spring (not shown) disposed on the deck 120 and the holder 140. After inserting or withdrawing the magnetic tape into/from the holder 140, the user pushes down the holder 140 so that the holder 140 moves downwardly and locks with the deck 120. Since the moving structure and the locking structure of the holder 140 are well known, descriptions thereof are omitted for clarity and conciseness.

A lower end of the FPC fixing member 210 is fixed to the deck 120 by a suitable fastener such as a bolt. The FPC 150 has a signal line for transmitting signals formed therein and is fixed to the FPC fixing member 210. Since a method of fixing the FPC 150 is well known, functions and constructions are omitted for clarity and conciseness. A part of an upper surface of the FPC fixing member 210 is open. The guide pole 110 is exposed through the opened portion to the outside, so that the height of the guide pole 110 may be adjusted from the outside. Further, the FPC fixing member 210 is extended to the upper side of the head drum 100. Due to the extension of the FPC fixing member 210, the FPC fixing member 210 covers the upper side of the head drum 100. Therefore, noise generated between the head drum 100 and the magnetic tape is prevented from being transmitted to the outside. Furthermore, since the FPC fixing member 210 extends to the upper side of the head drum 100, a separate space to install a member to prevent noise is not needed. Consequently, noise is effectively excluded, and a relatively compact size is maintained.

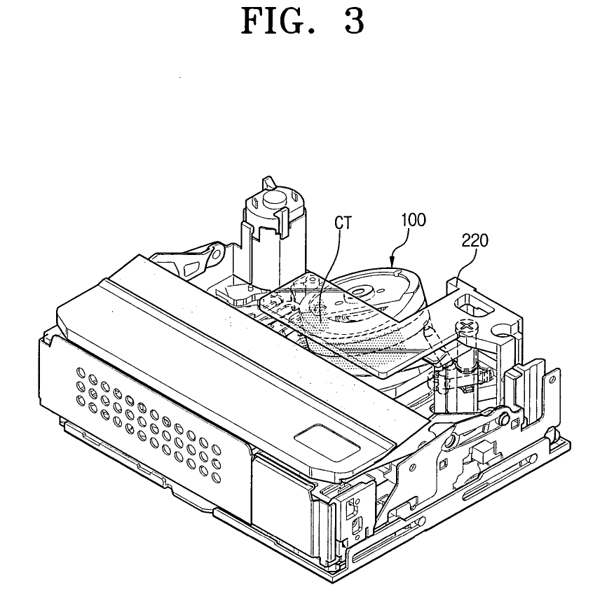

FIG. 3 is a schematic perspective view of the magnetic recording/reading apparatus in accordance with a second embodiment of the present invention.

Referring to FIG. 3, an FPC fixing member 220 extends only to an upper side of a contacting portion CT of the head drum on which the magnetic tape contacts. This structure prevents noise of the head drum from being transmitted to the outside, and also reduces costs of manufacturing and assembling the FPC fixing member 220.

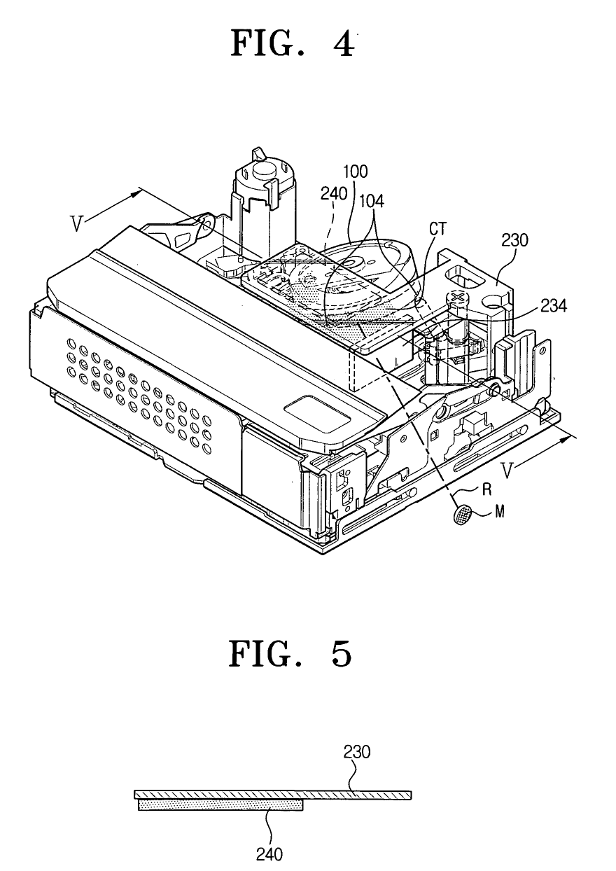

FIG. 4 is a schematic perspective view of the magnetic recording/reading apparatus in accordance with a third embodiment of the present invention. FIG. 5 is a cross-sectional view of an FPC fixing member taken along a line V-V of FIG. 4.

Referring to FIGS. 4-5, in an FPC fixing member 230 of the magnetic recording/reading apparatus according to a third embodiment of the present invention, a blocking shield 234 extends downward from the FPC fixing member 230 on a course R between a microphone M and the head drum 100. This is to prevent the noise generated between the head chip 104 and the magnetic tape from being input to the microphone M. Furthermore, an acoustic absorption member 240 is attached to at least one of the surfaces of the FPC fixing member 230 so as to be positioned at the upper side of the head drum 100. Preferably, the acoustic absorption member 240 is attached to the FPC fixing member 230 so as to be positioned on the upper side of the contacting portion CT of the head drum on which the magnetic tape contacts (referring to FIG. 4). The acoustic absorption member 240 preferably has a multi-patterned surface such as embossing, so as to effectively absorb the noise. Since acoustic absorption members 240 are well known, functions and descriptions of the structure are omitted for clarity and conciseness. Further, the acoustic absorption member 240 is preferably attached to the surface of the FPC fixing member 230 by an adhesive means such as bonding. The magnetic recording/reading apparatus in accordance with a third embodiment of the present invention further comprises the blocking shield 234 and the acoustic absorption member 240. Therefore, the noise generated between the head chip 104 and the magnetic tape is prevented from being input to the microphone M. Thus, the quality of recorded sound is improved, and the noise can be also effective reduced.

Furthermore, the acoustic absorption member preferably is not attached to one of the surfaces of the FPC fixing member. Instead, the acoustic absorption member is preferably connected with the FPC fixing member so that only the acoustic absorption member covers the upper side of the head drum. The acoustic absorption member and the FPC fixing member may be connected by any suitable connector or fastener, including bolts or adhesives. Furthermore, it should be understood that the acoustic absorption member, as described for this embodiment, may also be applied to the first and second embodiments.

According to the magnetic recording/reading apparatus according to embodiments of the present invention, the FPC fixing member extends to cover the upper side of the head drum so as to prevent noise generated between the head drum and the magnetic tape from being transmitted to the outside of the magnetic recording/reading apparatus. Thus, performance of the magnetic recording/reading apparatus is improved, while maintaining the compact size thereof.

Further, when recording information on the magnetic tape, the noise generated between the head drum and the magnetic tape is prevented from being transmitted to the outside of the magnetic recording/reading apparatus, thereby improving the quality of recorded sound.

While the invention has been shown and described with reference to certain embodiments thereof, it will be understood by those skilled in the art that various changes in form and details may be made therein without departing from the spirit and scope of the invention as defined by the appended claims.

1. A magnetic recording/reading apparatus, comprising:
a deck on which magnetic tape is arranged;
a head drum disposed on the deck to record or read information on/from the magnetic tape; and
a flexible printed circuit (FPC) fixing member disposed on the deck to fix an FPC having a signal line to transmit a signal, the FPC fixing member extending to an upper side of the head drum.

2. The apparatus as claimed in claim 1, wherein
the FPC fixing member is configured to cover only a contacting portion of the head drum which contacts the magnetic tape.

3. The apparatus as claimed in claim 1, wherein
the FPC fixing member further comprises a blocking shield disposed between a microphone and the head drum so as to exclude noise transmitted to the microphone.

4. The apparatus as claimed in claim 3, further comprising
an acoustic absorption member attached to at least one surface of the FPC fixing member.

5. The apparatus as claimed in claim 1, further comprising
an acoustic absorption member attached to at least one surface of the FPC fixing member.

6. A magnetic recording/reading apparatus, comprising:
a deck on which magnetic tape is arranged;
a head drum disposed on the deck to record or read information on/from the magnetic tape; and
a flexible printed circuit (FPC) fixing member disposed on the deck to fix an FPC having a signal line to transmit a signal, wherein the FPC fixing member extends to an upper side of the head drum and includes a blocking shield disposed between a microphone and the head drum so as to exclude noise transmitted to the microphone,
wherein the FPC fixing member is configured to cover only a contacting portion of the head drum which contacts the magnetic tape contacts.

7. The apparatus as claimed in claim 6, further comprising
an acoustic absorption member attached to at least one surface of the FPC fixing member.

8. A method of assembling a magnetic recording/reading apparatus, comprising the steps of:
providing a deck;
fixing a head drum on the deck to record or read information on/from magnetic tape; and
attaching a flexible printed circuit (FPC) to the deck such that the FPC extends to an upper side of the head drum.

9. The method of claim 8, wherein
the FPC fixing member is configured to cover only a contacting portion of the head drum which contacts the magnetic tape contacts.

10. The method of claim 8, wherein
the FPC fixing member further comprises a blocking shield disposed between a microphone and the head drum so as to exclude noise transmitted to the microphone.

11. The method of claim 8, further comprising the step of
attaching at least one surface of the FPC fixing member to an acoustic absorption member.
